(19) United States
(12) Patent Application Publication
(10) Pub. No.: US 2007/0092113 A1
(43) Pub. Date: Apr. 26, 2007

(54) Method and apparatus for obtaining facial images

(75) Inventors: Makoto Yonaha, Kanagawa-Ken (JP); Masahiro Kubo, Kanagawa-Ken (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 11/542,182

(22) Filed: Oct. 4, 2006

(30) Foreign Application Priority Data
Oct. 5, 2005 (JP) 292280/2005

(51) Int. Cl. G06K 9/00

(52) U.S. Cl. 382/115

(57) ABSTRACT

To prevent switching of users when obtaining facial images and biometric data of the hands of users, and to prevent obtainment of falsified biometric data from the hands of users. A facial image obtaining means obtains a facial image of a user. A biometric data obtaining means obtains biometric data of the hand of the user. A surveillance image obtaining means obtains a surveillance image of the hand and the face of the user, which is photographed simultaneously with the obtainment of the biometric data. The surveillance image is stored for a predetermined period of time.

### BACKGROUND OF THE INVENTION

1. Field of the Invention

The present invention relates to a method and apparatus for obtaining facial images, mainly for use in documents belonging to individuals, such as ID's and magnetic strip cards. More particularly, the present invention relates to amethod and apparatus that further has a function of obtaining biometric data of the hands of users, in addition to a function of obtaining facial images of the users.

2. Description of the Related Art

Presently, automated facial image obtaining apparatus that perform photography of subjects with cameras are installed in public places. These facial image obtaining apparatuses print the photographed facial images onto regular paper or paper having adhesive backings, and provides them to users.

Facial image obtaining apparatuses, which are capable of obtaining biometric data such as fingerprints, in addition to photographing facial images have also been proposed (refer to Japanese Unexamined Patent Publication Nos. 2003-208407 and 2005-196388). In these facial image obtaining apparatuses, surveillance images that include users' faces are photographed simultaneously, immediately prior to, or immediately following obtainment of the biometric data, to prevent switching of users when obtaining the biometric data.

The facial image obtaining apparatuses disclosed in Japanese Unexamined Patent Publication Nos. 2003-208407 and 2005-196388 can prevent switching of users. However, these apparatuses cannot prevent obtainment of falsified biometric data such as fingerprints, for example, by use of artificial fingers made of gelatin or a finger cover having a false fingerprint thereon.

### SUMMARY OF THE INVENTION

The present invention has been developed in view of the foregoing circumstances. It is an object of the present invention to provide a method and apparatus for obtaining facial images and biometric data of the hands of users, capable of preventing obtainment of falsified biometric data as well as switching of users.

A method for obtaining a facial image of a user according to the present invention comprises the steps of:

obtaining the facial image of the user;

obtaining biometric data from the hand of the user; wherein:

a surveillance image of the hand and the face of the user is photographed and obtained simultaneously with the obtainment of the biometric data.

A facial image obtaining apparatus according to the present invention comprises:

facial image obtaining means, for obtaining a facial image of a user;

biometric data obtainingmeans, for obtainingbiometric data from the hand of the user; and

surveillance image obtaining means, for obtaining a surveillance image of the hand and the face of the user, which is photographed simultaneously with the obtainment of the biometric data.

Here, the “biometric data from the hand of the user” refers to fingerprints, palm prints, palm shapes, patterns of veins in fingers, and patterns of veins in the palms of the hands. The phrase “simultaneously with the obtainment of the biometric data” means simultaneously, immediately prior to, or immediately following obtainment of the biometric data from the hand. Further, the “surveillance image of the hand and the face of the user” may be a single surveillance image that includes both the face and the hand of the user. Alternatively, the “surveillance image of the hand and the face of the user” may be images of the face and the hand of the user, which are continuously photographed. That is, the “surveillance image of the hand and the face of the user” may be a video image which is continuously photographed while panning a camera so as to photograph images of the hand and images of the face of the user.

The facial image obtaining apparatus of the present invention may further comprise: enlarged image obtaining means, for obtaining a enlarged image of the hand of the user. Various structures may be adopted as the enlarged image obtaining means. Specifically, a camera may be provided at the position of the hand of the user, separate from a camera for photographing the surveillance image. Alternatively, the lens of a camera for photographing the surveillance image may be provided with a higher magnification at a portion thereof that corresponds to the hand of the user. As a further alternative, the enlarged image obtaining means may be an image processing section that enlarges the portion that pictures the hand of the user, from within an image obtained by a camera for photographing the surveillance image.

The facial image obtaining means may also function as the surveillance image obtaining means.

The facial image obtaining apparatus may further comprise: surveillance image storing means, for storing the surveillance image photographed by the surveillance image obtaining means for a predetermined period of time.

In this case, a configuration may be adopted, wherein; the portion of the surveillance image that represents the face of the user is removed in advance prior to being stored in the surveillance image storing means.

In the facial image obtaining method and the facial image obtaining apparatus according to the present invention, a surveillance image of the hand and the face of the user, which is photographed simultaneously with obtainment of the biometric data from the hand of the user, is obtained. Therefore, switching of users and obtainment of falsified biometric data of hands can be prevented.

The facial image obtaining apparatus of the present invention may further comprise; the enlarged image obtaining means, for obtaining the enlarged image of the hand of the user. In this case, obtainment of falsified biometric data of hands can be more positively prevented.

The facial image obtaining means may also function as the surveillance image obtaining means. In this case, both the facial image and the surveillance image can be obtained with a single image obtaining means, and thereby the structure of the apparatus can be simplified.

The facial image obtaining apparatus may further comprise: the surveillance image storing means, for storing the surveillance image photographed by the surveillance image obtaining means for a predetermined period of time. In this case, the surveillance image may be viewed as necessary after obtainment thereof.

A configuration may be adopted, wherein: the portion of the surveillance image that represents the face of the user is removed in advance prior to being stored in the surveillance image storing means. In this case, leakage of facial images of individuals from surveillance images can be prevented.

### BRIEF DESCRIPTION OF THE DRAWINGS

FIG. 1 is a schematic diagram that illustrates the construction of a facial image obtaining apparatus according to a first embodiment of the present invention.

FIG. 2 illustrates the external appearance of the facial image obtaining apparatus of FIG. 1.

FIG. 3 illustrates an example of a command input screen.

FIG. 4 is a functional block diagram that illustrates a digital camera and a controller illustrated in FIG. 1.

FIG. 5 is a flow chart that illustrates the processes performed by the facial image obtaining apparatus of FIG.

FIG. 6 is a schematic diagram that illustrates the construction of a facial image obtaining apparatus according to a second embodiment of the present invention.

FIG. 7 is a schematic diagram that illustrates the construction of a facial image obtaining apparatus according to a variation of the second embodiment of the present invention.

### BEST MODE FOR CARRYING OUT THE INVENTION

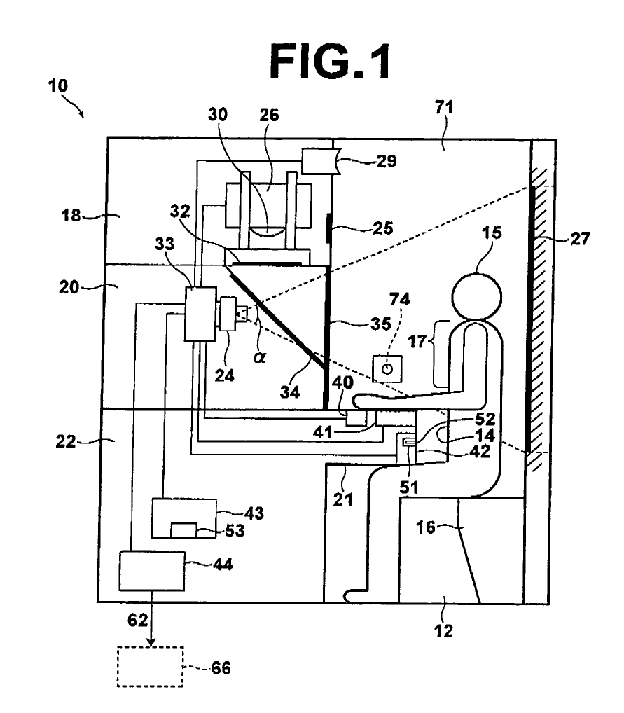

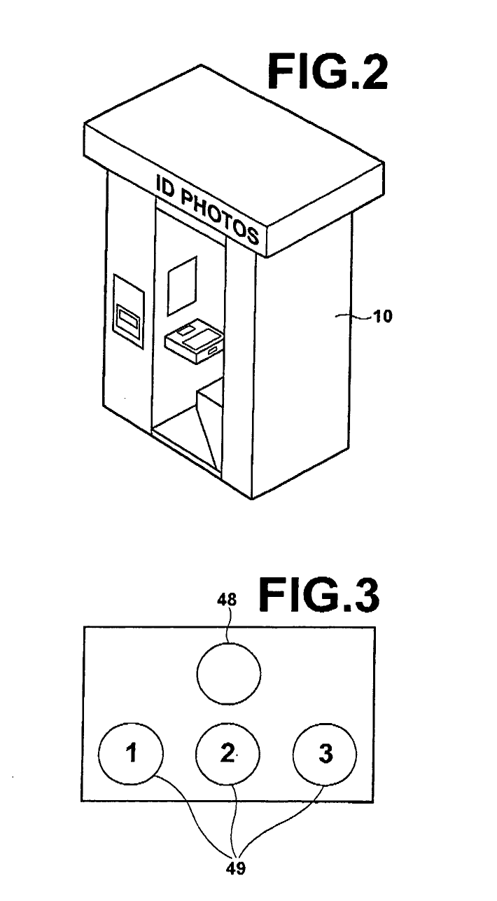

Hereinafter, a facial image obtaining apparatus 10 according to a first embodiment of the present invention will be described with reference to the attached drawings. FIG. 1 is a schematic diagram that illustrates the construction of the facial image obtaining apparatus 10. The shape of the facial image obtaining apparatus 10 is a rectangular parallelepiped as a whole, and is approximately 2.0 m high and 1.4 m wide. FIG. 2 illustrates the external appearance of the facial image obtaining apparatus 10.

As illustrated in FIG. 1, the facial image obtaining apparatus 10 comprises an approximately 75 cm wide photography chamber 12. Users 14 sit on a chair 16 provided in the photography chamber 12, and photography is performed.

The portion of the facial image obtaining apparatus 10 other than the photography chamber 12 is divided into an upper section 18, a middle section 20, and a lower section 22 that includes a desk 21. A digital camera 24 and a controller 33 are provided in the middle section 20. The controller 33 controls the operations of the entire facial image obtaining apparatus 10, including the operation of the digital camera 24. The angular field of view α of the lens of the digital camera 24 is wide, and covers a range of a rear wall 27 of the photography chamber 12 from a height of 60 cm to a height of 170 cm. Accordingly, when users 14 sit on the chair 16, their heads 15 and their upper bodies 17 can be positively photographed, and photography becomes possible regardless of the height of the user 14.

An illuminating apparatus 25, a CRT display 26, and a speaker 29 are provided in the upper section 18. The illuminating apparatus 25, the CRT display 26, and the speaker 29 are connected to the controller 33.

The CRT display 26 is capable of displaying video images and still images output thereto from the controller 33. A display screen 30 of the CRT display 26 is provided facing downward. The contents of display are projected through the border between the upper section 18 and the middle section 20 onto a half mirror 34 provided within the middle section 20.

The half mirror 34, which is inclined and provided between the digital camera 24 and the user 14, alternately reflects light from the CRT display 26 and the photography chamber 12. Meanwhile, a portion of the light from the photography chamber 12 propagates toward the digital camera 24, but light from the side of the digital camera 24 is shielded, and does not reach the photography chamber. Accordingly, users 14 are enabled to confirm the display contents projected onto the half mirror 34 through a glass window 35, but are not able to see the digital camera 24. However, the digital camera 24 is capable of photographing images of users 14, by the light that passes through the half mirror 34 and reaches the digital camera 24.

The illuminating apparatus 25 illuminates the photography chamber 12 to maintain brightness sufficient for photography therein. The speaker 29 prompts users 14 to input commands regarding the operation of the facial image obtaining apparatus 10 with audio messages.

A fingerprint obtaining section 40, a touch panel 41 for operating the facial image obtaining apparatus 10, a card writer 42, a printer 43, and a modem 44 are provided in the lower section 22. The fingerprint obtaining section 40, the touch panel 41, the card writer 42, the printer 43, and the modem 44 are connected to the controller 33. Note that the fingerprint obtaining section 40, the touch panel 41, and the card writer 42 are housed within the desk 21.

The fingerprint obtaining section 40 is a semiconductor fingerprint sensor, and is configured to automatically obtain digital data that represents fingerprints in cases that fingers contact a region greater than or equal to a predetermined area.

The touch panel 41 outputs signals to the controller 33, based on operations thereof by users 14. The touch panel 41 is capable of switching display between: an information input screen, by which personal information, such as the name, the resident registration code number, the passport number and the like of the user 14 is input; and a command input screen, by which operation commands by the user 14 are input. A keyboard is displayed in the information input screen. A photography button 48, for commanding photography of facial images, and selectionbuttons 49, for selecting a facial image to be written into a recording medium (to be described later) from among photographed facial images, are displayed in the command input screen, as illustrated in FIG. 3. Note that the semiconductor fingerprint sensor 40 is built into the portion of the touch panel 41 at which the photography button 48 is displayed. The semiconductor fingerprint sensor 40 is configured to automatically obtain a fingerprint only when a user touches the photography button 48 while the command input screen is being displayed.

The card writer 42 comprises an insertion opening 52, for users 14 to insert their own recording media 51 into, and is capable of writing onto the inserted recording media. Flexible disks, Smart Media™, Compact Flash™, Memory Stick™, SD™ (Secure Digital) memory cards, and xD™ (Extreme Digital) picture cards are examples of recording media 51 that can be employed.

The card writer 42 writes digital image data of a face photographed by the digital camera 24 into the recording media 51, along with fingerprint data of the right and left index fingers obtained by the fingerprint obtaining section 40.

The printer 43 is capable of printing the images photographed by the digital camera 24 as photographic prints. The printed photographs are discharged from a discharge opening 53.

The modem 44 is a communication means for transmitting digital image data of a user's face to a predetermined location, such as a management center 66, via communication lines 62, if desired by the user.

For the sake of convenience, the interiors of the upper section 18, the middle section 20, and the lower section 22 are made visible in FIG. 1. However, in actuality, all of the components except for the fingerprint obtaining section 40, the touch panel 41, the insertion opening 52 of the card writer 42, and the discharge opening 52 of the printer 43 are hidden by walls, and not visible to users 14. In addition, although omitted from the drawing, a money insertion slot, an opening for dispensing change, and the like are provided in the lower section 22.

A surveillance camera 74 for continuously photographing users 14 is provided on a side wall 71 of the facial image obtaining apparatus 10. The surveillance camera 74 has a wide angular field of view, and is capable of obtaining surveillance images in which the face and the hand of a user are photographed simultaneously. Note that the surveillance camera 74 is mounted on the side wall 71 about 10 cm higher than a position directly beside the fingerprint obtaining section 40 and such that it is capable of photographing the fingerprint obtaining section 40 and the faces of users 14. The focal distance of the lens of the surveillance camera 74 is set such that the focal distance is short at the lower portion thereof and long at the upper portion thereof. An infra-red LED (Light Emitting Diode) camera may be employed as the surveillance camera 74, for example. The surveillance images photographed by the surveillance camera 74 are output to the controller 33.

The controller 33 stores an image data set that represents a still surveillance image obtained when fingerprint data is obtained, from among the images obtained by the surveillance camera 74, correlated with various data. The data that the image data set is correlated with includes: the personal information of a user, the authenticating fingerprint data, and a unique ID number of the facial image obtaining apparatus 10 or data that represents the date/time of photography. The image data set that represents the surveillance image obtained when the fingerprint data is obtained is stored for a predetermined period of time. Alternatively, the controller 33 may transmit the image data set along with the various data to the remote management center 66 via the modem 44 and communication lines 62. Note that the image data set that represents the still surveillance image may include an enlarged image of the portion that represents the hand of the user in addition to the entirety of the surveillance image.

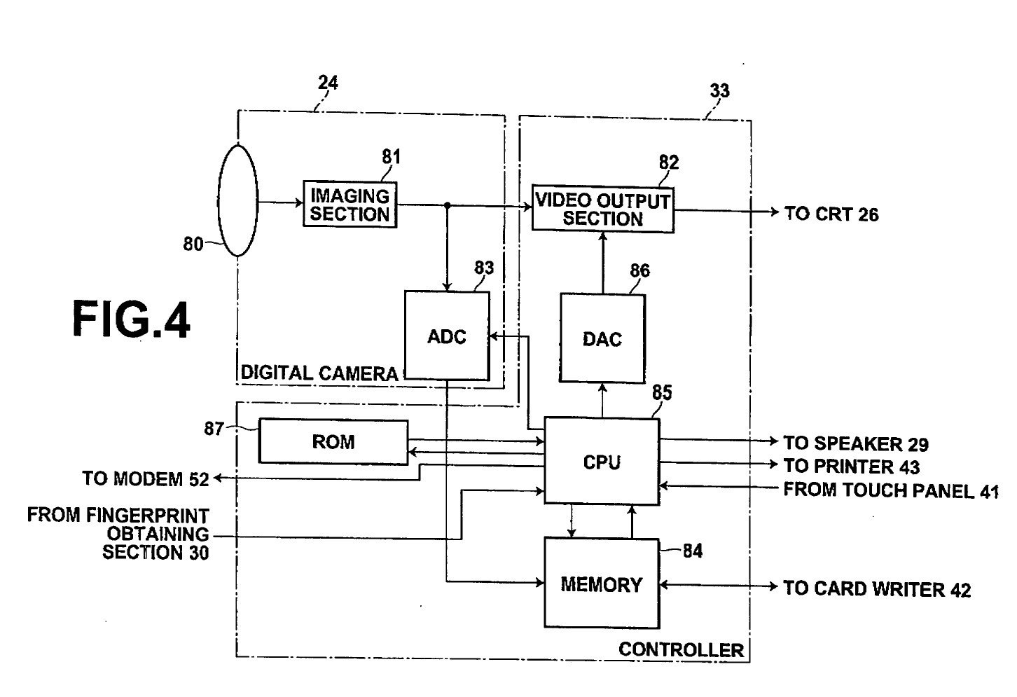

FIG. 4 is a functional block diagram that illustrates the digital camera 24 and the controller 33 of FIG. 1. An optical lens 80 receives light from a subject (a user 14) and focuses an image of the subject onto a light receiving surface of an imaging section 81. A CCD (Charge Coupled Device) may be employed as the imaging section 81, for example. An image signal, which has been photoelectrically converted by the imaging section 81, is output to a video output section 82.

The video output section 82 generally transmits the image signal output thereto from the imaging section 81 to the CRT display 26, via an output terminal. Accordingly, the video image of the user 14 is read by the digital camera 24, output to and displayed by the CRT display 26, and reflected by the half mirror 34, to be viewable by the user 14. Causing the video image to be viewed by the user 14 will be referred to hereinafter as “video throughput”. The user 14 is enabled to view video images of themselves in real time by the video throughput.

The image signal output from the imaging section 81 may also be output to an A/D (Analog/Digital) converter 83. When facial images are photographed, the A/D converter 83 converts the image signal, which is an analog signal, to adigital image signal, and stores the signal in a memory 84.

A CPU 85 (Central Processing Unit) is connected to and controls the A/D Converter 83, the memory 84, and a D/A (Digital/Analog) converter 86. During photography, the CPU 85 transmits conversion commands to the A/D converter 83, and causes the A/D converter 83 to perform analog/digital conversion on a video image signal in one frame units. The CPU 85 is capable of reading out the digital image signals which have been digitized and stored in the memory 84, perform various image processes thereon, and re-store them in the memory 84.

The CPU 85 correlates the personal information input via the touch panel 41, such as the name, the resident registration code number, and the passport number of the user 14, with the facial image data obtained by photography with the digital camera 24. The CPU 85 also correlates the authenticating fingerprint data, the unique ID number of the facial image obtaining apparatus 10 and data that represents the date/time of photography with the facial image data.

The correlation may be performed by various methods. For example, the file name of the facial image data may employ the personal information. Alternatively, text data may be recorded within the header portion of the digital facial image data, and the data may be integrally stored in the memory 84. In this manner, digital facial image data, which can be discriminated as belonging to specific individuals by the correlated personal information, are generated.

The CPU 85 is capable of outputting digital still images, on which image processes have been administered, and transmitting them to the video output section 82 after D/A conversion is performed by the D/A converter 86. At this time, the video output section 82 is controlled to output the analog still image signal instead of the analog video image signal which is being throughput. Thereby, users are enabled to view the photographed still images, on which image processes have been administered. In addition, the analog still image signal and the analog video image signal may be output in either color or back and white.

The CPU 85 can display the photographed image, on which image processes have been administered, in any layout on the CRT display 26. In addition, simple animations may be displayed on the CRT display 26, by displaying a plurality of still images which are stored in the memory 84 in advance frame by frame. Further, output of graphics is enabled via the video output section 82, and messages for users 14 may be displayed on the CRT display 26.

The CPU 85 is also connected to the speaker 29, and audio signals which are prepared in advance may be output to the speaker 29, to instruct users 14 regarding appropriate commands for each operation by audio guidance.

The CPU 85 is also connected to the printer 43 and the touch panel 41. Still images, on which image processes have been administered, may be output to the printer 43 from the CPU 85 according to a print command, and photographic prints may be generated. In addition, the CPU 85 receives commands via the touch panel 41, and performs processes according to commands input by users 14.

The CPU 85 is further connected to a ROM 87 (Read Only Memory). The ROM 87 has recorded therein at least a plurality of image processing programs and specifications of ID photos. The specifications of ID photos include data related to the size of photographs to be printed, and the size and position of head portions within the photographs. The CPU 85 accesses the ROM 87, reads out various programs and specifications of ID photos as appropriate, and administers image processes on still facial images read out from the memory 84 to generate photographs that match the specifications.

The CPU 85 judges whether the fingerprint data obtained by the fingerprint obtaining section 40 is utilizable for authentication. In the case that it is judged that the fingerprint data is utilizable for authentication, the fingerprint data is stored in the memory 84 as authenticating fingerprint data. The CPU 85 also judges whether fingerprint data obtained by the fingerprint obtaining section matches authenticating fingerprint data.

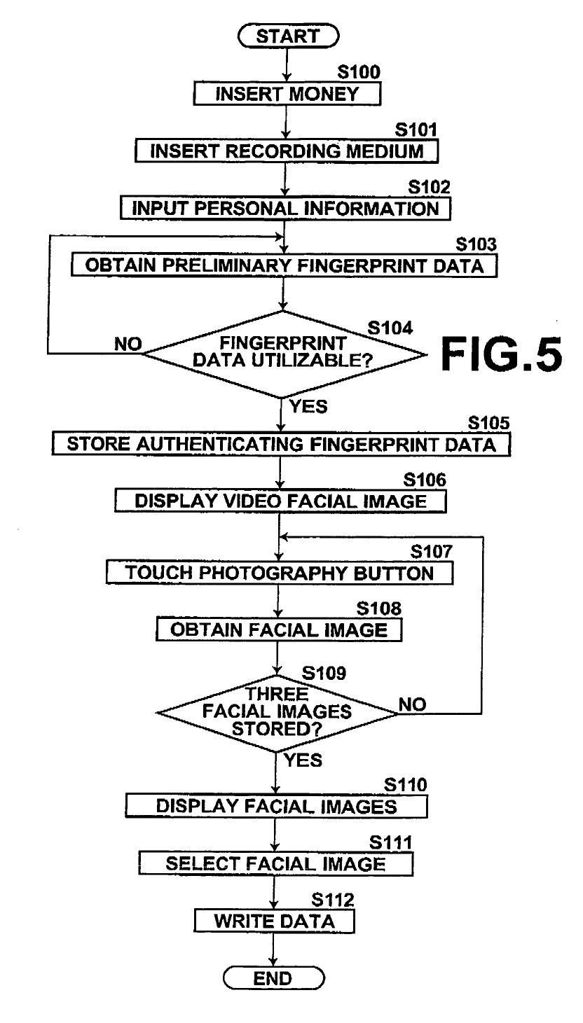

The operation of the facial image obtaining apparatus 10 according to the first embodiment as described above will be described hereinbelow. FIG. 5 is a flow chart that illustrates the processes performed by the facial image obtaining apparatus 10. All of the operations of the facial image obtaining apparatus 10 are prompted by audio messages output by the speaker 29. A user 14 first inserts money into the money insertion slot (step 100), to start up the facial image obtaining apparatus 10. Next, the user 14 inserts a recording medium 51 into the insertion opening 52 of the card writer 42 (step 101). Thereafter, the user 14 inputs personal information, such as their name and their resident registration code via the touch panel 41, on which the information input screen (keyboard) is being displayed (step 102). Then, digital data of the fingerprints of the right and left index fingers of the user 14 are preliminarily obtained by the fingerprint obtaining section 40 (step 103). The controller 33 extracts characteristic points from the fingerprint data, and judges whether there are enough characteristic points necessary for fingerprint authentication therein (step 104). That is, judgment is performed regarding whether the fingerprint data are utilizable for fingerprint authentication. In the case that the fingerprint data are judged to not be utilizable for fingerprint authentication, the process returns to step 103, and the user 14 is prompted to enable the facial image obtaining apparatus 10 to re-obtain fingerprint data. In the case that the fingerprint data are judged to be utilizable for fingerprint authentication, the process proceeds to step 105, and the fingerprint data are stored in the memory 84 of the controller 33 as authenticating fingerprint data.

Thereafter, the facial images of the user 14 being imaged by the digital camera 24 are displayed on the CRT display 26 by video throughput (step 106). Note that the touch panel 41 is switched over to the command input screen. The user 14 observes the facial image of him/herself which is being displayed on the CRT display 25, and touches the photography button 48 at a desired timing (step 107). A still image of the user's face is obtained by the digital camera 24 when the photography command is input, and stored in the memory 84 of the controller 33 (step 108).

In step 109, it is judged whether three facial image data sets are stored in the memory 84. In the case that three facial image data sets are not stored in the memory 84, the process returns to step 107, and the user is prompted to re-touch the photography button 48. In the case that three facial image data sets are stored in the memory 84, the process proceeds to step 110, and the three facial images represented by the facial image data sets are displayed on the CRT display 26. The user 14 selects a desired facial image by touching one of the selection buttons 49 (step 111).

At step 112, the controller 33 writes the facial image data set selected in step 111, correlated with the authenticating fingerprint data, the user's personal information, such as the name, the resident registration code number, and the passport number of the user, the unique ID of the facial image obtaining apparatus 10 and data indicating the date/time of photography, into the recording medium 51 inserted in the insertion opening 52 of the card writer 42.

Note that the aforementioned data may be transmitted to a predetermined location, such as a management center 66, via communication lines 62, if desired by the user 14. Alternatively, the aforementioned data may be printed out.

Note that when the user 14 inserts money at step 100, photography by the surveillance camera 74 is initiated. When the facial image data is recorded in the recording medium 51 at step 111, photography by the surveillance camera 74 is ceased. As described previously, the surveillance images photographed by the surveillance camera 74 are output to the controller 33. The controller 33 stores an image data set that represents a still surveillance image obtained when fingerprint data is obtained at step 103, from among the images obtained by the surveillance camera 74, correlated with various data. The data that the image data set is correlated with includes: the personal information of the user 14, the authenticating fingerprint data, and the unique ID number of the facial image obtaining apparatus 10 or data that represents the date/time of photography. The image data set that represents the surveillance image obtained when the fingerprint data is obtained is stored for a predetermined period of time.

Alternatively, the image data set that represents the surveillance image obtained when the fingerprint data is obtained may be transmitted along with the various data to the remote management center 66 via the modem 44 and communication lines 62.

The management center 66 may display the surveillance image on a monitor to be observed in real time, in addition to maintaining the surveillance image data set. Alternatively, the surveillance image may be analyzed by a computer or the like, and notification may be sent or the operation of the facial image obtaining apparatus 10 may be automatically ceased, if any abnormalities appear in the surveillance images. The image data set that represents the still surveillance image may include an enlarged image of the portion that represents the hand of the user in addition to the entirety of the surveillance image. Note that in the case that the surveillance image is observed at the management center 66, video signals of the surveillance images may be observed.

As is clear from the description above, the facial image obtaining apparatus 10 according to the first embodiment of the present invention obtains a surveillance image of the hand and the face of the user 14, which is photographed simultaneously with the obtainment of the fingerprint data. Therefore, switching of users and obtainment of falsified biometric data of hands can be prevented.

Further, the photographed surveillance image is stored for a predetermined period of time. Therefore, the surveillance image maybe viewed as necessary after obtainment thereof. In addition, if an enlarged image of the hand of the user is obtained, falsification of fingerprint data becomes easier to detect, and obtainment of falsified fingerprint data can be more positively prevented.

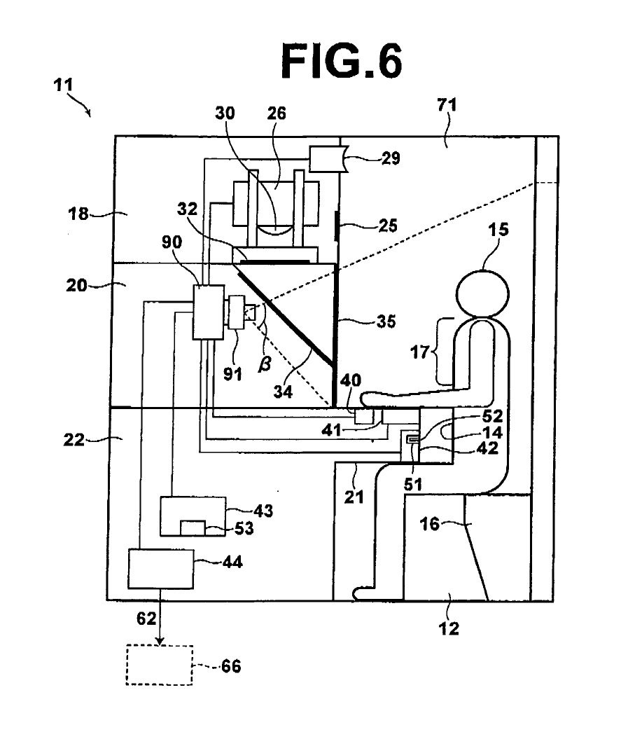

Next, an facial image obtaining apparatus 11 according to a second embodiment of the present invention will be described with reference to FIG. 6. In the facial image obtaining apparatus 11, a digital camera 91 for obtaining facial images also functions to obtain surveillance images. Note that components of the facial image obtaining apparatus 11 which are in common with those of the facial image obtaining apparatus 10 of the first embodiment illustrated in FIG. 1 will be denoted with the same reference numerals, and detailed descriptions thereof will be omitted insofar as they are not particularly necessary.

The angular field of view β of the lens of the digital camera 91 is wide, and covers a range of a rear wall 27 of the photography chamber 12 from a height of 0 cm to a height of 170 cm. Accordingly, when users 14 sit on the chair 16, their heads 15, their upper bodies 17, and the fingerprint obtaining section 40 can be positively photographed.

The digital camera 91 is connected to a controller 90. Note that the operations of the digital camera 91 and the controller 90 are the same as those of the digital camera 24 and the controller 33 of the first embodiment, except for the fact that surveillance images are also obtained thereby. Descriptions of operations which are the same as those of the first embodiment will be omitted.

First, a user 14 inserts money into the money insertion slot, to initiate photography of images by the digital camera 91. When facial image data is recorded in the recording medium 51, photography by the digital camera 91 is ceased. The surveillance images photographed by the digital camera 91 are output to the controller 90. The controller 90 stores an image data set that represents a still surveillance image obtained when fingerprint data is obtained, from among the images obtained by the digital camera 91, correlated with various data. The data that the image data set is correlated with includes: the personal information of the user 14, the authenticating fingerprint data, and the unique ID number of the facial image obtaining apparatus 11 or data that represents the date/time of photography. The image data set that represents the surveillance image obtained when the fingerprint data is obtained is stored for a predetermined period of time. Note that as in the first embodiment, the image data set that represents the surveillance image obtained when the fingerprint data is obtained may be transmitted along with the various data to the remote management center 66 via the modem 44 and communication lines 62. In addition, the image data set that represents the still surveillance image may include an enlarged image of the portion that represents the hand of the user in addition to the entirety of the surveillance image.

As is clear from the description above, the facial image obtaining apparatus 11 according to the second embodiment of the present invention can prevent switching of users and obtainment of falsified fingerprints. In addition, the construction of the apparatus is simplified, because the digital camera 91 obtains both the facial image and the surveillance images.

Further, a configuration may be adopted, wherein the portion of the surveillance image that represents the face of the user is removed in advance prior to the surveillance image being stored. In this case, leakage of facial images of individuals from surveillance images can be prevented. Note that the facial image to be written into the recording medium 51 can be cut out from the still image when the fingerprint data is obtained, and the remaining image may be stored as the surveillance image.

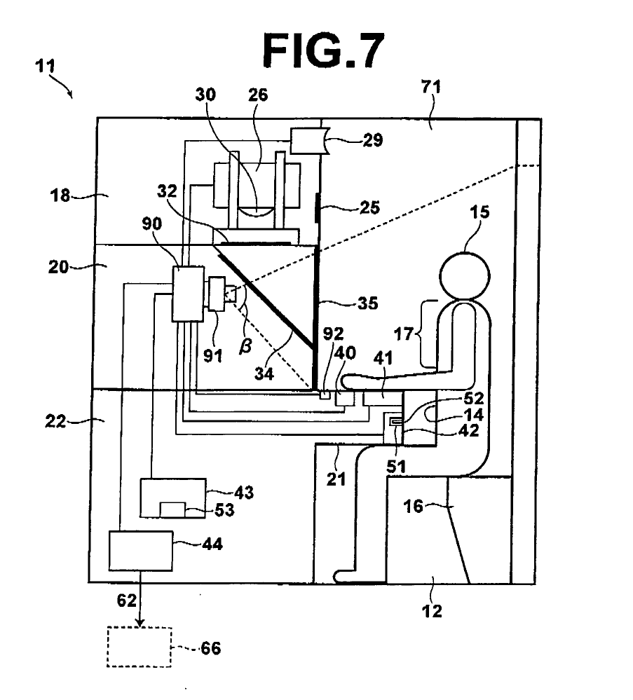

Note that a variation of the facial image obtaining apparatus 11 of the second embodiment may be considered, as illustrated in FIG. 7. The facial image obtaining apparatus 11 illustrated in FIG. 7 is provided with a camera 92 for obtaining enlarged images of users' hands. The enlarged images obtained by the camera 92 are output to the controller 90, incorporated into the still surveillance image data set, and stored or transmitted. Falsification of biometric data of the hands can be more positively prevented, because highly detailed surveillance images of the hands can be obtained.

In each of the embodiments described above, cameras having wide angular fields of view were employed to obtain the still surveillance images Alternatively, the surveillance image may be images of the face and the hand of the user, which are continuously photographed by panning a regular camera. That is, the surveillance image may be a video image which is continuously photographed while panning a camera so as to photograph images of the hand and images of the face of the user.

What is claimed is:

1. A method for obtaining a facial image of a user, comprising the steps of:
obtaining the facial image of the user;
obtaining biometric data from the hand of the user; wherein:
a surveillance image of the hand and the face of the user is photographed and obtained simultaneously with the obtainment of the biometric data.

2. A facial image obtaining apparatus, comprising:
facial image obtaining means, for obtaining a facial image of a user;
biometric data obtaining means, for obtaining biometric data from the hand of the user; and
surveillance image obtaining means, for obtaining a surveillance image of the hand and the face of the user, which is photographed simultaneously with the obtainment of the biometric data.

3. A facial image obtaining apparatus as defined in claim 2, further comprising:
enlarged image obtaining means, for obtaining a enlarged image of the hand of the user.

4. A facial image obtaining apparatus as defined in claim 2, wherein:
the facial image obtaining means functions as the surveillance image obtaining means.

5. A facial image obtaining apparatus as defined in claim 3, wherein:
the facial image obtaining means functions as the surveillance image obtaining means.

6. A facial image obtaining apparatus as defined in claim 2, further comprising:
surveillance image storing means, for storing the surveillance image photographed by the surveillance image obtaining means for a predetermined period of time.

7. A facial image obtaining apparatus as defined in claim 5, further comprising:
surveillance image storing means, for storing the surveillance image photographed by the surveillance image obtaining means for a predetermined period of time.

8. A facial image obtaining apparatus as defined in claim 6, wherein:
the portion of the surveillance image that represents the face of the user is removed in advance prior to being stored in the surveillance image storing means.

9. A facial image obtaining apparatus as defined in claim 7, wherein;
the portion of the surveillance image that represents the faceof the user is removed in advance prior to being stored in the surveillance image storing means.
